(19) United States
(12) Patent Application Publication
(10) Pub. No.: US 2004/0110404 A1
(43) Pub. Date: Jun. 10, 2004

(54) PICK UP MECHANISM FOR SOCKET CONNECTOR

(75) Inventor: WenXin Wang, Kunsan (CN)

Correspondence Address: WEI TE CHUNG, FOXCONN INTERNATIONAL, INC., 1650 MEMOREX DRIVE, SANTA CLARA, CA, 95050, US

(73) Assignee: HON HAI PRECISION IND. CO., LTD., Tu-Chen (TW)

(21) Appl. No.: 10/604,484

(22) Filed: Jul. 24, 2003

(30) Foreign Application Priority Data
Dec. 6, 2002 (TW) 91219762

(51) Int. Cl. H01R 13/15

(52) U.S. Cl. 439/260

(57) ABSTRACT

A pick up mechanism (2) is for carrying a socket connector (1). The socket connector defines first and second cutouts (123, 124). The pick up mechanism has a plate member (21). First and second retention protrusions (215, 216) depend from the plate member, for respectively engaging in the first and second cutouts. Thus the pick up mechanism is held on the socket connector. A sign cutout (2141) is defined at one corner (2140). The remaining corners (2142) all have a same configuration different from the configuration of the first corner. Thus the plate member has an asymmetrical configuration relative to a longitudinal and a transverse axis lines thereof. As a result, a correct orientation of the pick up mechanism is easily determined during its attachment onto the socket connector.

### BACKGROUND OF INVENTION

1. Field of the Invention

The present invention relates to a pick up mechanism, and more particularly to a pick up mechanism for carrying a socket connector such as a CPU (central processing unit) socket connector.

2. Description of Related Art

A pick up mechanism is commonly used to allow carrying of an socket component such as CPU socket by a vacuum-suction device, which then places the electrical component onto a printed circuit board (PCB). Referring to FIGS. 5 and 6, a conventional pick up mechanism 8 is used for carrying a CPU socket connector 6. The connector 6 includes a base 60, and a cover 62 slidably mounted on the base 60. A rectangular opening 620 is defined in the cover 62. First and second cutouts (not visible) are defined at corresponding internal sides of the opening 620. The pick up mechanism 8 has a rectangular plate member 80. A smooth top surface (not labeled) is formed on the plate member 80. First and second retention protrusions 82, 84 depend from a bottom surface of the plate member 80, the first and second retention protrusions 82, 84 respectively engaging in the first and second cutouts. Thus the pick up mechanism 8 is held on the CPU socket connector 6. After that, a vacuum-suction device (not shown) sucks the top surface of the pick up mechanism 8 so as to carry the pick up mechanism 8 and the connector 6 onto a PCB.

However, the plate member 80 has a symmetrical configuration, making it unduly difficult to ascertain a correct orientation of the pick up mechanism 8 during its attachment to the connector 6. Therefore an operator must turn over the plate member 80 to ascertain the correct orientation prior to mounting the pick up mechanism 8 onto the connector 6. As a result, the assembly procedure is unduly inefficient.

Thus, there is a need to provide an improved pick up mechanism for a socket connector to overcome the above-mentioned problems.

### SUMMARY OF INVENTION

Accordingly, one main object of the present invention is to provide a pick up mechanism for carrying a socket connector, wherein a correct orientation of the pick up mechanism is easily determined during its attachment onto the socket connector.

To fulfill the above-mentioned objection, a pick up mechanism for carrying a socket connector is provided according to the present invention. The socket connector defines first and second cutouts thereon. The pick up mechanism comprises a plate member. First and second retention protrusions depend from a bottom surface of the plate member, for respectively engaging in the first and second cutouts. Thus the pick up mechanism is held on the socket connector. A sign cutout is defined at one corner of the plate member. The remaining corners have a same configuration different from the configuration of the one corner. Thus the plate member has an asymmetrical configuration relative to a longitudinal and a transverse axis lines thereof. As a result, a correct orientation of the pick up mechanism is easily determined during its attachment onto the socket connector.

Other objects, advantages and novel features of the present invention will become more apparent from the following detailed description when taken in conjunction with the accompanying drawings, in which:

### BRIEF DESCRIPTION OF DRAWINGS

FIG. 1 is a simplified, isometric view of a pick up mechanism according to the present invention, and a socket connector for use with the pick up mechanism;

FIG. 2 is an enlarged, inverted view of a cover of the socket connector of FIG. 1;

FIG. 3 is an inverted view of the pick up mechanism of FIG. 1;

FIG. 4 is an enlarged, isometric inverted view of the pick up mechanism and the cover of FIG. 1 engaged together;

FIG. 5 is a simplified, isometric view of a conventional pick up mechanism, and a socket connector for use with the pick up mechanism; and

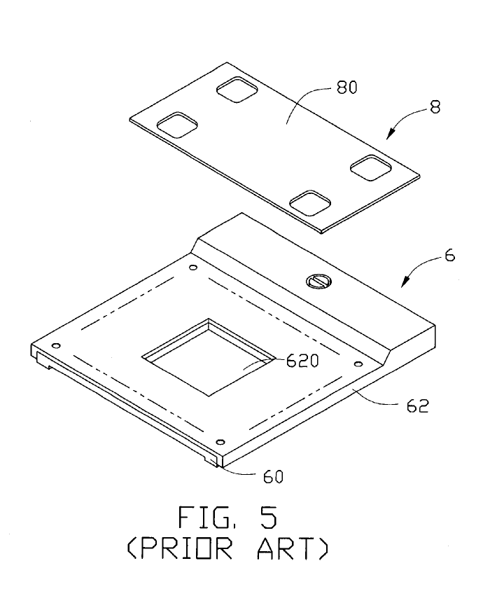

FIG. 6 is an inverted view of the pick up mechanism of FIG. 5.

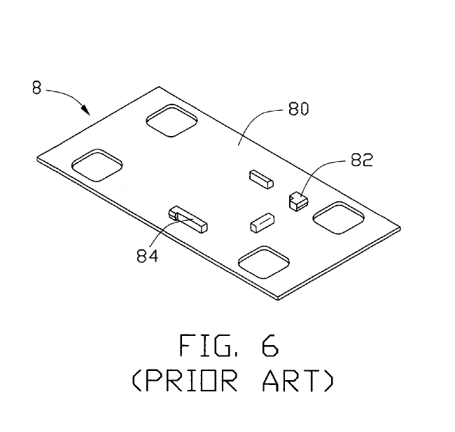

### DETAILED DESCRIPTION

Reference will now be made to the drawings to describe the present invention in detail.

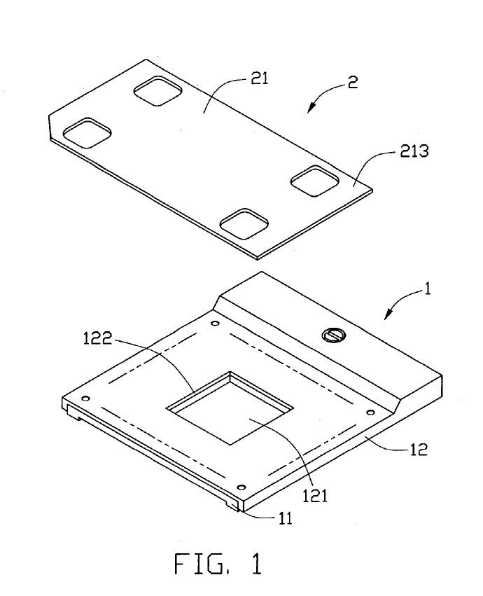

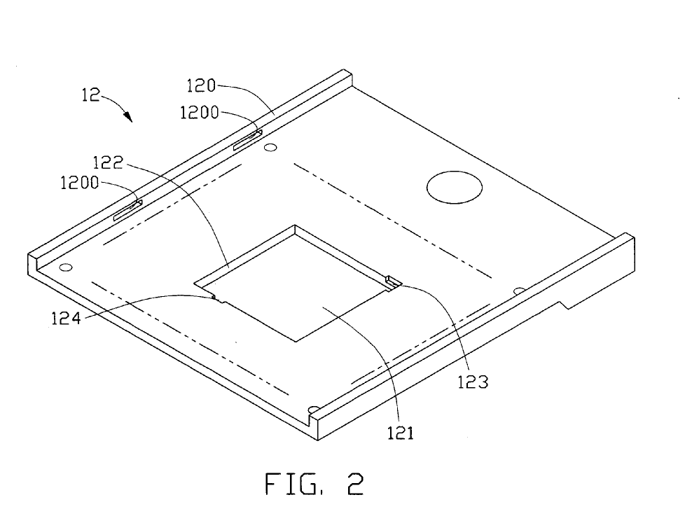

Referring first to FIGS. 1 and 2, a pick up mechanism 2 according to the present invention is used to pick up a socket connector such as a socket connector 1. The socket connector 1 comprises a base 11, and a cover 12 slidably mounted on the base 11. A rectangular opening 121 is defined in a middle of the cover 12. Four internal sides 122 are formed on the cover 12, surrounding the opening 121. A first cutout 123 is defined in a junction of two adjacent of the internal sides 122. The first cutout 123 has an “L” shaped configuration. A rectangular second cutout 124 is defined in another of the internal sides 122. The first and second cutouts 123, 124 are disposed substantially diagonally opposite from each other across the opening 121. A pair of side walls 120 depends from opposite lateral edges of the cover 12 respectively. Two rectangular recesses 1200 are defined in each side wall 120. Two protrusion blocks (not visible) are formed on each of opposite lateral sides of the base 11, for engaging in the corresponding recesses 1200. Thus the cover 12 is slidably held on the base 11. Further, the socket connector 1 includes an actuator device (not labeled) for urging the cover 12 to slide relative to the base 11.

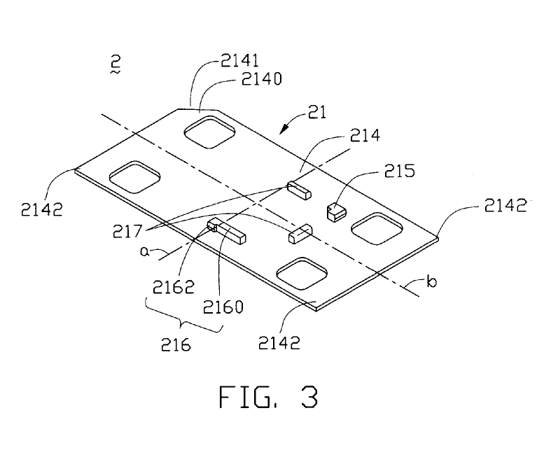

Referring also to FIG. 3, the pick up mechanism 2 comprises a rectangular plate member 21. It should be understood that the plate member 21 can be formed to have other alternative shapes, for example octagonal, pentagonal, circular and so on. The plate member 21 defines a bottom surface 214 and a smooth top surface 213. The top surface 213 is adapted for being sucked by a vacuum-suction device. A first retention protrusion 215 and a second retention protrusion 216 unitarily extend from the bottom surface 214, respectively corresponding to the first and second cutouts 123, 124. The first retention protrusion 215 has an “L”-shaped configuration, for being fittingly received in the first cutout 123. The second retention protrusion 216 comprises a base portion 2160. A blocking protrusion 2162 is formed at one end of the base portion 2160, for being fittingly received in the second cutout 124. Two stoppers 217 are formed on the bottom surface 214 perpendicular to each other, for engaging corresponding internal sides 122 of the cover 12.

A triangular sign cutout 2141 is defined in one corner 2140 of the plate member 21. It should be understood that the sign cutout 2141 can have other alternative shapes, for example rectangular, arcuate and so on. Three remaining second corners 2142 of the plate member 21 are unbevelled. It should also be understood that the second corners 2142 can have other alternative configurations, for example curved and so on. Whatever configuration is chosen, the second corners 2142 all have a same configuration, which is different from the configuration of the first corner 2140. Thus the plate member 21 is asymmetrical relative to a longitudinal axis ‘b’ thereof, and is also asymmetrical relative to a transverse axis ‘a’ thereof. Accordingly, the plate member 21 is easily recognized during its attachment to the socket connector 1.

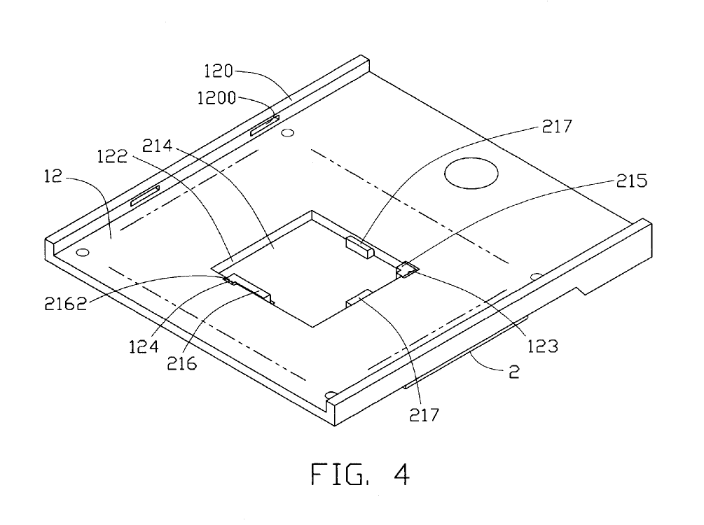

Referring also to FIG. 4, in assembly, the actuator device is sandwiched between the cover 12 and the base 11. The protrusion blocks (not visible) of the base 11 are engaged in the corresponding recesses 1200 of the cover 12, thereby slidably holding the cover 12 on the base 11. The stoppers 217 abut the corresponding internal sides 122, thereby pre-positioning the pick up mechanism 2 on the cover 12. The first retention protrusion 215 engages in the first cutout 123, and the blocking protrusion 2162 engages in the second cutout 124. Thus the pick up mechanism 2 is held on the cover 12, thereby connecting the pick up mechanism 2 and the socket connector 1 together.

The sign cutout 2141 of the first corner 2140 provides the first corner 2140 with a configuration that is different from the configuration of each of the second corners 2142. The plate member 21 is asymmetrical relative to the longitudinal axis ‘b’ thereof, and relative to the transverse axis ‘a’ thereof. Thus an operator can easily recognize a correct orientation of the pick up mechanism 2 during use. As a result, the pick up mechanism 2 can be efficiently attached onto the socket connector 1.

1. A pick up mechanism for a socket connector comprising:
a plate member having retention means for picking up the socket connector, and defining a sign means formed on an edge of the plate member to shape the plate member asymmetrical relative to a longitudinal and a transverse axis lines, respectively.

2. The pick up mechanism of claim 1, wherein the sign means is at least one cutout defined at the edge of the plate member.

3. The pick up mechanism of claim 2, wherein the cutout is triangular.

4. The pick up mechanism of claim 3, wherein the plate member defines a smooth top surface and a bottom surface.

5. The pick up mechanism of claim 4, wherein the retention means is retention protrusions depending from the bottom surface of the plate member.

6. The pick up mechanism of claim 5, wherein stoppers depend from the bottom surface of the plate member.

7. The pick up mechanism of claim 6, wherein the stoppers are perpendicular to each other.

8. An assembly comprising:
an electrical socket defining rectangular housing with a rectangular opening in a central opening thereof;
a plurality of first engaging devices formed asymmetrically along a periphery of said opening;
a pick up mechanism roughly defining a rectangular plate member with a plurality of second engaging devices formed asymmetrically on an underside thereof and coupled to the corresponding first engaging devices, respectively; wherein
an orientation mark is upwardly exposed to an exterior in a vertical direction whereby it is easy for an operator to downwardly assemble the pick up mechanism to the socket with correct orientation.

9. The assembly of claim 8, wherein said orientation mark is a cutout at a corner of said plate member.

10. A pick up mechanism for use with an electrical connector, comprising:
a rectangular plate member having retention means formed on an underside thereof for picking up the connector, and defining a sign means upwardly exposed to an exterior to reshape the plate member to be equipped with an orientation function so as to make sure of non-interference between said retention means and said connector during assembling.
